(19) United States
(12) Patent Application Publication
(10) Pub. No.: US 2026/0216826 A1
(43) Pub. Date: Jul. 30, 2026

(54) Method for Controlling a Laser Source, in Particular a Pulsed Laser Source, for Cutting, Engraving, Marking and/or Labeling a Workpiece, and Laser Plotter therefor

(71) Applicant: Trotec Laser GmbH, Marchtrenk (AT)

(72) Inventors: Josef GREIL, Rohr im Kremstal (AT); Paul HAGER, Bad Wimsbach (AT)

(21) Appl. No.: 19/159,000

(22) PCT Filed: Feb. 2, 2024
(86) PCT No.: PCT/EP2024/052570

§ 371 Date: Aug. 22, 2025

(30) Foreign Application Priority Data
Feb. 22, 2023 (AT) A 50122/2023

(51) Int. Cl. B23K 26/352; B23K 26/00; B23K 26/062; B23K 26/38; B41J 2/44; B41J 25/00; B41J 29/00

(52) U.S. Cl. CPC B23K 26/352; B23K 26/0006; B23K 26/0626; B23K 26/38; B41J 2/442; B41J 25/001; B41J 29/00

(57) ABSTRACT

A laser plotter and a method for controlling a laser source for cutting, engraving, marking, and/or labeling a workpiece is disclosed. In a housing of a laser device, at least one laser source is used to process a workpiece, which is preferably placed on a processing table. The workpiece is processed line by line by moving a focusing unit or laser head. Based on the set parameters and/or a loaded job, a control unit generates a frequency signal to control the laser source. At the beginning of the processing operation, the control unit calculates a number of laser pulses for a pixel/path unit. From this, a modulation signal is generated that enables the laser source to emit laser pulses at the constant pulse repetition rate. This signal is applied to the laser source, and the number of laser pulses is kept constant across further pixels/path units.

### TECHNICAL FIELD

The present disclosure relates to a method for controlling a laser source, in particular a pulsed laser source, for cutting, engraving, marking and/or labeling a workpiece, as well as a laser plotter for this purpose, as described in claims 1 and 10.

### DESCRIPTION OF THE RELATED ART

From the prior art, laser devices, particularly laser plotters, are already known in which one or more laser sources are operated. Such laser plotters include a carriage driven by a belt drive, on which a focusing unit or laser head is also adjustably mounted. Preferably, flat workpieces such as paper, boards, textiles, pens, mobile phones, tablets, etc., are processed by a laser beam, which is directed from the laser source via deflection elements to the focusing unit or laser head and from there deflected toward the workpiece. The laser device, particularly the laser plotter, includes a control unit for controlling and regulating all components. During the processing of a workpiece, the laser source emits laser pulses at a constant pulse repetition rate, which are sent to the focusing unit during a pixel (image point).

A disadvantage here is that, due to the constant laser pulses, different amounts of energy are introduced per pixel when the pixel lengths vary, such as during acceleration and deceleration phases, which negatively affects engraving quality.

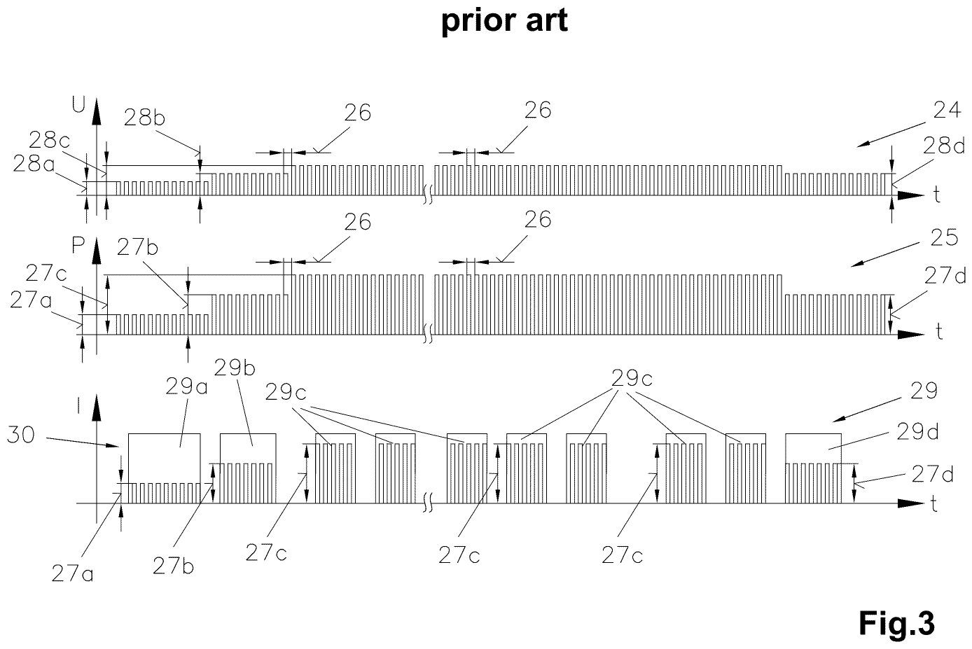

Previously, the applicant attempted to avoid this by reducing the predefined laser power of the laser pulses during longer pixels, especially in acceleration (29a, b) and deceleration (29d) phases, to reduce the introduced energy, since the pulsed laser pulses are emitted over the entire duration of the pixels, as shown in FIG. 3. However, this is very complex and difficult to calculate and adjust for all different pixels.

### SUMMARY OF EMBODIMENTS

The object of the present disclosure is to provide a method for controlling a laser source, in particular a pulsed laser source, for cutting, engraving, marking and/or labeling a workpiece, and a laser plotter for this purpose, which avoids the aforementioned disadvantages and ensures high engraving quality.

This object is achieved by the disclosed embodiments. Advantageous embodiments and procedural measures are described in the dependent claims.

The object of the present disclosure is achieved by a method in which, at the beginning of the processing operation or laser processing, particularly before each line or path unit, a number of laser pulses for a pixel/path unit is calculated by the control unit. From this, a modulation signal is generated that enables the laser source to emit laser pulses at the constant pulse repetition rate, and this signal is applied to the laser source. The calculated number of laser pulses is kept constant across further pixels/path units.

An advantage here is that, for the first time, the same number of laser pulses with predefined power is emitted for each pixel/path unit. That is, regardless of the length of a pixel/path unit, the same number of laser pulses is always emitted, either by releasing the laser pulses for a corresponding duration via the modulation signal or by counting the pulses, particularly their rising or falling edges. This ensures that the total pulse energy per path unit or pixel can be kept constant, even at varying speeds, especially during acceleration and deceleration. Furthermore, by scaling the number of pulses per path unit or pixel, a grayscale mode is also possible.

The major advantage over the prior art is that the energy introduced per path unit/pixel is constant. This is independent of the processing speed (acceleration, deceleration); otherwise, energy input would vary with speed changes.

It is advantageous to calculate the number of laser pulses using the parameters of graphical resolution (DPI, dots per inch), processing speed, and the pulse repetition rate of the constant laser pulses. This allows optimal adjustment of the energy input into the workpiece.

It is also advantageous to calculate the number of laser pulses per pixel/path unit using the formula:

Repetition rate/(Resolution×Processing speed)=Number of laser pulses per pixel/path unit

This allows for a simple calculation of the number of laser pulses.

It is further advantageous to always round the result of the number of laser pulses per pixel/path unit, particularly to round down. This ensures that only complete laser pulses are emitted.

Preferably, the set target value is used as the parameter for processing speed. This allows for a straightforward calculation using the set speed value.

It is also advantageous that the pixels during acceleration and deceleration of the focusing unit or laser head have different lengths, particularly different durations, while the number of laser pulses remains the same, especially constant. This ensures that the same amount of energy is always introduced into the workpiece, regardless of pixel length.

It is advantageous that the calculated modulation signal is applied for each pixel/path unit to release the laser pulses. This ensures that laser pulses are only emitted within the modulation signal, allowing for longer pixel durations.

It is also advantageous to consider additional parameters, particularly grayscale, for a grayscale mode when calculating the number of laser pulses. This allows pixels to be represented not only in black and white but also in various grayscale levels, which is also visible in the engraving on the workpiece.

Furthermore, it is advantageous in grayscale mode to calculate a new number of laser pulses using the formula:

Repetition rate×Grayscale factor/(Resolution×Processing speed)=Number of laser pulses per pixel/path unit,

where the grayscale factor can take a value between 0 and 1. This allows grayscale to be engraved on the workpiece.

The object of the present disclosure is also achieved by a laser plotter in which the control unit is configured to calculate and apply a number of laser pulses to the focusing unit or laser head according to one of claims 1 to 9.

The disclosed embodiments are subsequently described in the form of an exemplary embodiment, with the note that the present disclosure is not limited to the illustrated and described embodiment or solution, but can be applied to equivalent solutions.

### BRIEF DESCRIPTION OF DRAWINGS

### Figures

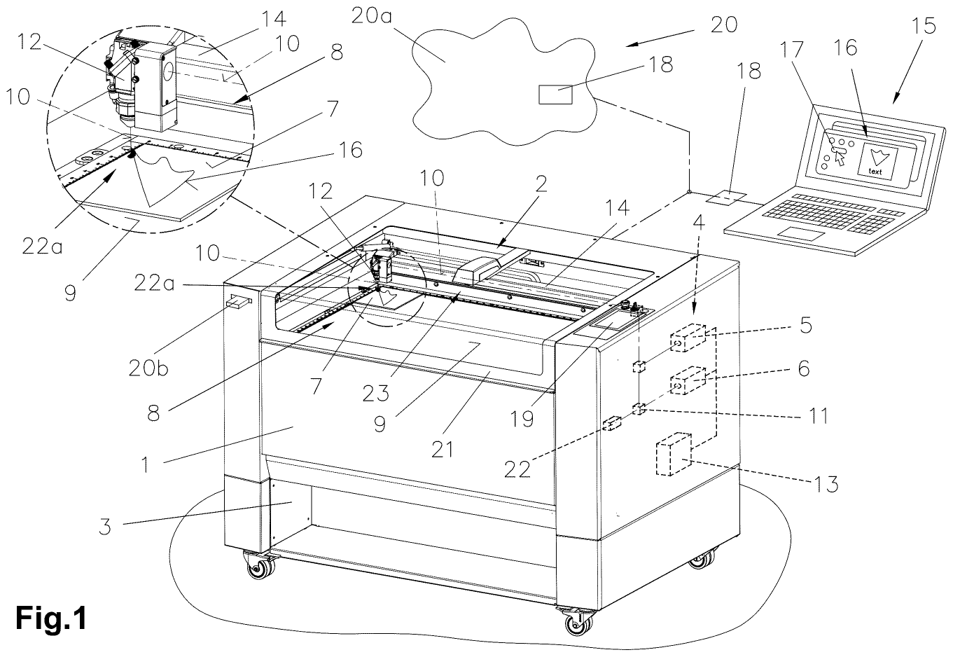

FIG. 1: A schematic illustration of a laser device for processing a workpiece using a laser process, shown in simplified, diagrammatic form.

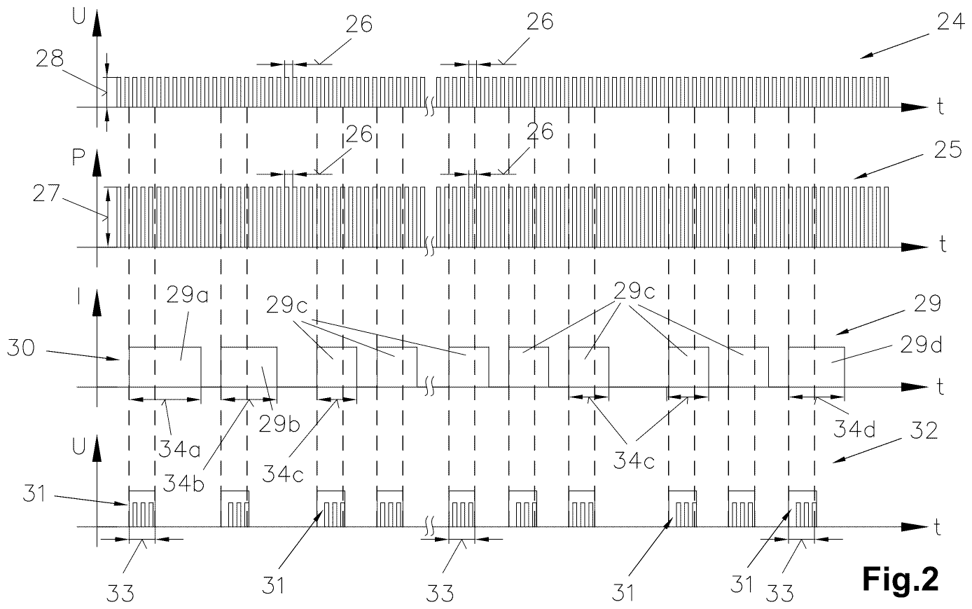

FIG. 2: A signal profile of the laser processing for a line with modulation signal, shown in simplified, diagrammatic form.

FIG. 3: A signal profile of laser processing from the prior art, shown in simplified, diagrammatic form.

Introductory Note: In the various embodiments, identical parts are provided with identical reference numerals or identical component designations. The disclosures contained throughout the description can be analogously applied to identical parts with identical reference numerals or component designations. Furthermore, the positional indications used in the description, such as top, bottom, side, etc., refer to the illustrated figures and should be interpreted accordingly if the orientation changes.

### DETAILED DESCRIPTION OF EMBODIMENTS

In FIGS. 1 to 3, an exemplary embodiment of a laser device 1, in particular a laser plotter 1, preferably equipped with a camera system 2, is shown, in which a method for controlling a laser source, in particular a pulsed laser source, for cutting, engraving, marking, and/or labeling a workpiece is carried out.

Within a housing 3, at least one, preferably two, radiation sources 4 or laser sources 4 in the form of lasers 5 and 6 are arranged. The lasers 5 and 6 preferably act alternately on the workpiece 7 to be processed, which is positioned in a processing chamber 8 of the laser plotter 2, preferably on a processing table 9, which is preferably height-adjustable. A laser beam 10, preferably pulsed and emitted by the laser source 4, is directed via deflection elements 11 to at least one movable focusing unit 12 or laser head 12, from which the laser beam 10 is deflected toward the workpiece 7 and focused for processing.

Control, in particular position control of the laser beam 10 relative to the workpiece 7, is performed via software running on a control unit 13. The workpiece 7 is preferably processed line by line by moving a carriage 14, on which the focusing unit 12 or laser head 12 is also movably arranged, preferably driven by a belt drive in the X-Y direction.

It is possible, for example, that in the processing mode “engraving,” the carriage 14 is moved line by line, whereas in the processing mode “cutting,” the carriage 14 is moved according to the contour to be cut, i.e., not line by line. Of course, it is also possible that in the “engraving” mode, the carriage 14 is moved along the contour to be cut, i.e., performing a so-called vector engraving, in which a path unit is traversed.

Furthermore, a graphic 16 and/or text 16 is created or loaded on an external component 15, in particular a computer, laptop 15a, or control device, using standard software 17 such as CorelDraw, Paint, etc., or using proprietary application software 17, in particular Ruby 17. This is then exported or transferred to the control unit 13 of the laser device or laser plotter 1 in the form of a job 18. Preferably, the data to be transferred is converted by the same or another software so that the control unit 13 can process the job 18.

It is also possible to input data directly on the laser plotter 1 via existing input means 19, such as a touchscreen 19 or input buttons, or to load a corresponding job 18 from a storage medium 20, such as a cloud 20a, USB stick 20b, etc. Once the data, in particular the job(s) 18, has been transferred or created directly or loaded from the storage medium 20, the laser device 1 or laser plotter 1, in particular its control unit 13, executes the job 18. It is possible for multiple jobs 18 to be stored simultaneously in the laser device 1, in particular the laser plotter 1, and processed sequentially.

For such laser devices 1, in particular laser plotters 1, it is necessary for safety reasons that, before starting a job 18 in which the laser beam 10 acts on the workpiece 7, a cover 21 or door 21, preferably at least partially transparent, is closed, as shown in FIG. 1.

Subsequently, the operator can manually or automatically position the laser point or a laser pointer 22, in particular laser pointer spot 22a, which is coupled into the beam path of lasers 5 and 6 and deflected via the focusing unit 12 or laser head 12 toward the processing table 8, onto the inserted workpiece 7. The job 18 for processing the workpiece 7 with the transferred settings, such as laser power, processing speed, resolution, table height, exhaust system, etc., can then be started.

At the end of job 18, the carriage 14 and the focusing unit 12 or laser head 12 are preferably returned to the starting position so that the finished workpiece 7 can be removed, and a new processing operation can be started by inserting a new workpiece 7 or blank 7.

For completeness, it is noted that repositioning of the focusing unit 12 or laser head 12 with the laser pointer 22 activated is also possible with the cover 21 open; however, the lasers 5 and 6 cannot be activated in this state.

In the illustrated embodiment, at least one camera 23 is additionally provided in the camera system 2, with the camera 23 located in the cover 21, preferably centrally in the middle of the cover 21. The camera 23 is intended to capture the processing chamber 8, in particular the processing table 9, so that an inserted workpiece 7 on the processing table 9 can be detected and preferably displayed on the external component 15, in particular the laptop 15a, and/or on the screen/touchscreen of the laser device 1.

The detection of the position of the workpiece 7 preferably takes place before processing or the start of the processing operation, so that the focusing unit 12 or laser head 12 can be positioned, via the laser pointer 22, at the location shown in the image, for example to begin processing or to determine the height of the processing table 9.

For completeness, it is noted that detection of the position of the workpiece 7 is also possible with the cover 21 open, i.e., an image of the processing table 9 or the processing chamber 8 can be captured even when the cover 21 is open.

To generate a laser beam 10 for the processing operation, the laser source 4 is controlled using a frequency signal 24, as shown in FIG. 2, so that corresponding laser pulses 25 with a constant pulse repetition rate 26, in particular a constant frequency, are generated. The frequency signal 24 can be generated directly by the control unit 13 or via a frequency generator, whereby the pulse height 28 of the frequency signal 24 preferably determines the power level 27 or laser power 27 for the laser pulse 25 proportionally, and/or the laser power 27 is transmitted from the control unit 13 to the laser source 4 via a signal.

When using a frequency generator, it is preferably controlled by the control unit 13. Alternatively, the laser source 4 can also be controlled by a control signal that includes at least the pulse repetition rate 26 and laser power 27, so that the laser source 4 generates laser pulses 25 with a constant pulse repetition rate 26, in particular frequency.

It is essential that the laser beam 10 is formed by laser pulses 25 with a constant pulse repetition rate 26, whereby the pulse height 28 preferably determines the laser power 27 of lasers 5 and 6. That is, depending on the set laser power 27, a proportional pulse height 28 is preferably applied to the laser source 4, so that the laser source 4 generates laser pulses 25 with a constant pulse repetition rate 26.

Preferably, the laser device 1 operates using a so-called raster engraving method, in which the workpiece 7 is processed line by line via image points 29, also referred to as pixels 29. That is, the graphic 16 or text 16 consists essentially of or is converted into individual image points 29 or pixels 29, so that the software of the control unit 13 controls the laser source 4 in such a way that the laser beam 10 is switched on for black pixels, i.e., existing image points 29, and switched off for white pixels, i.e., no image points 29.

FIG. 2 shows a line 30 of a processing operation with image points 29a-d, where typically the image points 29c, at a given processing speed of the laser head 12, are always of equal length, i.e., equal size. However, during the acceleration phase (image points 29a, b) and deceleration phase (image point 29d), the image points 29a, b, d are of varying lengths, i.e., different sizes, as shown in FIG. 2.

For completeness, it is also noted that instead of raster engraving, where line 30 is engraved point by point, a vector engraving method can also be used, in which the laser head 12 moves along lines and thus defines so-called path units instead of image points 29. In vector engraving, the laser pulses 25 are calculated for a path unit.

In the novel laser plotter 1 or laser device 1 according to the present disclosure, a new method is now provided for controlling the laser source 4, in particular a pulsed laser source, in which a number 31 of optical laser pulses 25 per image point/path unit 29 is calculated. That is, for the image points 29 or pixels 29 of a line 30 or path unit, a specific number 31 of laser pulses 25 per image point/path unit 29 is permitted, and a laser beam 10 is generated with the number 31 of laser pulses 25 per image point/path unit 29.

To emit or provide only a specific number 31 of laser pulses 25 during a pixel 29 from the laser source 4, a novel modulation signal 32 is preferably sent from the control unit 13 to the laser source 4. This modulation signal 32 enables the laser source 4 over a calculated duration 33, which corresponds at least to the calculated number 31 of laser pulses 25 at a given pulse repetition rate 26, or to the number of pulses counted via rising or falling edges, so that the laser pulses 25 are emitted as a laser beam 10.

Preferably, the modulation signal 32 with the duration 33, as shown in FIG. 2, is applied during the pixels 29. At the beginning of a pixel 29, the modulation signal 32 is also sent to the laser source 4, so that the laser pulses 25 are emitted from the laser source 4 at a constant pulse repetition rate 26. The laser pulses 25 are continuously generated, as shown in FIG. 2, and are only emitted as a laser beam 10 during the presence of a pixel 29 and a modulation signal 32, corresponding to the duration 33. That is, the laser pulses 25 are continuously generated and only emitted according to the duration 33 of the modulation signal 32, which is calculated so that a specific number 31 of laser pulses 25 is emitted within the duration 33 of the modulation signal 32.

As shown in FIG. 2, the duration 33 of the modulation signals is shorter than the pixel duration 34, so that the energy introduced via the laser pulses 25 for the pixels 29 remains constant. That is, for varying pixel durations 34a-d, especially due to acceleration and deceleration phases, the duration 33 of the modulation signals 32 remains the same, ensuring that the same number 31 of laser pulses 25 is introduced per pixel/path unit 29, regardless of how long the pixel duration 34a-d of the pixels 29a-d is.

Fundamentally, it should be noted that the duration 33 of the modulation signal 32 can correspond to the pixel duration 34 at maximum speed, so that the laser pulses 25 are applied over the entire pixel duration 34 of a pixel 29.

In summary, the control unit 13 generates, based on the set parameters and/or a loaded job 18, a frequency signal 24 to control the laser source 4 with a constant pulse repetition rate 26, in particular frequency, or a control signal for laser pulses 25 with a constant pulse repetition rate 26, in particular frequency. At the beginning of the processing operation or laser processing, especially before each line 30 or path unit, the control unit 13 calculates a number 31 of laser pulses 25 for a pixel/path unit 29, from which a modulation signal 32 is generated that enables the laser source 4 to emit laser pulses 25 at the constant pulse repetition rate 26. This signal is applied to the laser source 4, and the calculated number 31 of laser pulses 25 is kept constant across further pixels/path units 29. That is, each pixel/path unit 29 is exposed to the same number 31 of laser pulses 25, with the modulation signal 32 applied during each pixel/path unit 29.

Furthermore, FIG. 2 shows that the modulation signal 32 can vary slightly, specifically, if a laser pulse 25 has already started and the modulation signal 32 ends within that pulse, the modulation signal 32 is extended until the end of the laser pulse 25. This ensures that the number 31 of laser pulses 25 is fully emitted with full power. If the modulation signal 32 starts during a laser pulse 25, the next complete laser pulse 25 is emitted, ensuring that the full power and number 31 of laser pulses 25 are always emitted.

The activation time or duration 33 of a pulsed laser 5, 6 or laser source 4 is calculated such that a constant number 31 of laser pulses 25 is achieved for a defined path unit or pixel 29 along the travel path of the laser beam 10 or laser head 12. For this calculation, the following set parameters are used, preferably:
the graphical resolution (DPI, dots per inch),
the travel speed, and
the pulse repetition rate of the constant laser pulses,
the following formula is used:

$$Repetition rate 26 / ( Resolution \times Travel speed ) = Number 31 of laser$$

$$pulses 25 per pixel / path unit 29$$

For example, the following parameters can be selected or set for a job 18 on the external component 15, in particular on the laptop 15a or on the laser device 1:
Resolution: 800 dpi
Travel speed: 2 m/s (equivalent to 78.74 inches/s)
Laser pulse/Pulse repetition rate: 200 kHz (200,000 Hz)
this results in:

$$200 , 000 / ( 800 \times 78.74 ) = 3.175$$

Since only an integer number 31 of laser pulses 25 is possible, the result of 3.175 is rounded down to 3 laser pulses 25 per pixel 29.
From the number 31 of 3 laser pulses 25, the duration 33 of the modulation signal is then calculated using the formula:

$$Number 31 / Repetition rate 26 = Duration 33$$

this results in:

3/200,000=0.000015 s (15 μs)

Thus, the duration 33 of the modulation signal 32 for each pixel/path unit 29 is 15 μseconds.

It is also possible to consider additional parameters in the calculation, as is the case, for example, with grayscale engravings, i.e., in a grayscale mode. In this case, the grayscale parameter or pixel frequency is taken into account. The grayscale mode is an extension of the previously described calculation, in which the number 31 of maximum laser pulses 25 is reduced depending on the grayscale level, and the pulse duration or time duration 33 is then recalculated or optimized.

For grayscale mode, the following formulas can be applied:

$$Rounded value of ( Number 31 \times Grayscale factor ) = New number 31$$

The grayscale factor is defined by the selected grayscale level in relation to the maximum possible grayscale level, in particular 8-bit grayscale, as: Grayscale level/256
For example, if the previously calculated number 31 of laser pulses 25 is 3 and a grayscale level of 192 is selected, the formula yields:

$$Rounded value of ( 3 \times ( 192 / 256 ) ) = 2$$

This results in a new number 31 of 2 laser pulses 25. Assuming a repetition rate of 200 kHz (200,000 Hz), the time duration 33 of the modulation signal 32 can again be calculated as:

$$2 \times 1 / 200 , 000 = 0.0 \; 0001 s ( 10 μs )$$

Thus, the time duration 33 of the modulation signal 32 in grayscale mode would be 10 microseconds, meaning that under this parameter configuration, only 2 laser pulses 25 per pixel/path unit 29 would be emitted or applied in grayscale mode.

An individual grayscale factor, and thus an individual number of pulses, can be calculated for each pixel/path unit.

For completeness, it is noted that this example is provided for illustrative purposes only. Each pixel can have or represent an individual grayscale value.

The calculation of the number 31 of laser pulses 25, particularly the modulation signal 32, per line 30 can be performed by the control unit 13 either before each line 30 or for multiple, or even all, lines 30 in advance.

FIG. 3 shows a signal profile from the prior art. It illustrates that laser pulses 25 are emitted during the pixels 29. However, during the acceleration and deceleration phases, i.e., at the beginning and end of a line 30, the pixels 29 have a longer duration, which would result in too much energy being introduced into the workpiece 7 at a given laser power 27. To avoid this, in the prior art, the applicant has attempted to adjust the laser power 27a-d by applying a corresponding frequency signal 24 with a corresponding pulse height 28a-d, which requires significant control effort.

This high control effort is avoided in the present disclosure by introducing the modulation signal 32, which limits the number 31 of laser pulses 25 per pixel 29, allowing the laser power 27 to remain unchanged and ensuring that a constant amount of energy is introduced into the workpiece 7 even during acceleration and deceleration phases.

It is also advantageous to use the maximum speed set on the external component 15 or the laser device 1 as the processing speed.

In general, it can be said that the number 31 of laser pulses 25 increases with the pulse repetition rate 26 of the pulsed laser 5, 6 and decreases with increasing graphical resolution (dpi) and higher processing speed. By keeping the number of pulses 31, and thus the total energy introduced per pixel 29, constant, adjustments to other parameters of the laser source 4, as required in the prior art, are no longer necessary or become secondary.

For completeness, it is noted that the application or emission of the modulation signal 32 occurs simultaneously with or immediately after the execution of a pixel 19. Furthermore, the calculation of the number 31 of laser pulses 25 can be performed before each line 30, for a defined number of lines 30, or at the beginning of processing for all lines 30.

Additionally, individual features or combinations of features from the various embodiments shown and described can form independent, inventive, or invention-relevant solutions.

For the sake of clarity, it is noted that the present disclosure is not limited to the illustrated embodiments but may also include further configurations and constructions.

1. A method for controlling a laser source, for cutting, engraving, marking, and/or labeling a workpiece, wherein at least one laser source is used within a housing of a laser device to process a workpiece and the processing of the workpiece is carried out line by line by moving a focusing unit wherein a control unit, based on the set parameters and/or a loaded job, generates a frequency signal to control the laser source with a constant pulse repetition rate, or a control signal for laser pulses with a constant pulse repetition rate, wherein at the beginning of processing, the control unit calculates a number of laser pulses for a pixel, from which a modulation signal is generated that enables the laser source to emit laser pulses at the constant pulse repetition rate, and this signal is applied to the laser source, whereby the calculated number of laser pulses is kept constant across further pixels.

2. The method according to claim 1, wherein the calculation of the number of laser pulses is based on parameters of graphical resolution, processing speed, and the pulse repetition rate of the constant laser pulses.

3. The method according to claim 1, wherein the number of laser pulses per pixel/path unit is calculated using the formula: Repetition rate/(Resolution×Processing speed)=Number of laser pulses per pixel/path unit.

4. The method according to claim 3, wherein the processing speed uses a set target value.

5. The method according to claim 1, wherein the calculation of the number of laser pulses per pixel/path unit is rounded down.

6. The method according to claim 1, wherein the pixels during acceleration and deceleration of the focusing unit have different lengths while the number of laser pulses remains the same, in particular constant.

7. The method according to claim 1, wherein for each pixel/path unit, the calculated modulation signal is applied to release the laser pulses.

8. The method according to claim 1, wherein a grayscale parameter is considered in the calculation of the number of laser pulses for a grayscale mode.

9. The method according to claim 1, wherein, in a grayscale mode, a new number of laser pulses is calculated using the formula: “Rounded value of (Number 31×Grayscale factor)=New number 31, “where the grayscale factor is formed by the formula: “Adjustable grayscale level/Maximum grayscale level, in particular 8-bit grayscale of 256”, and each individual pixel can be assigned its own grayscale factor.

10. A laser for plotter for engraving, marking and/or labeling a workpiece, comprising a processing chamber for positioning a workpiece, at least one, laser source in the form of a laser with pulsed laser pulses, corresponding deflection elements a movable focusing unit, and a control unit for controlling a carriage driven by a belt drive, with the focusing unit movably arranged thereon, wherein the control unit is configured to calculate and apply a number of laser pulses to the focusing unit.
